(19) United States
(12) Patent Application Publication
(10) Pub. No.: US 2007/0152559 A1
(43) Pub. Date: Jul. 5, 2007

(54) Cathode ray tube suspension device

(75) Inventors: Massimo De Marino, Colleferro, RM (IT); Paolo Ginesti, Gavignano (RM) (IT); Marco Malcosti, Colleferro, RM (IT)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING INC.

(21) Appl. No.: 11/649,607

(22) Filed: Jan. 4, 2007

(30) Foreign Application Priority Data
Jan. 5, 2006 (IT) MI2006A000014

(51) Int. Cl. H01J 29/10

(52) U.S. Cl. 313/476; 313/477 R

(57) ABSTRACT

Suspension lug of a cathode ray tube comprising weld zones on the anti-implosion frame of the tube, the said weld zones extend in a first direction over a length L and according to a second direction perpendicular to the first over a length l, shorter than the length L. At least one of the weld zones extends in a direction contained in a plane different from the plane in which the other weld zones extend. This structure can increase the solidity of the welds and limit their number.

The present invention relates to a cathode ray tube and more particularly to an anti-implosion device in the form of a metal frame equipping such a tube.

### BACKGROUND OF THE INVENTION

Cathode ray tubes, used for example in television receivers, are formed by a glass envelope in which a hard vacuum is applied.

This envelope comprises a glass panel composed of a front face surrounded by a peripheral flange noticeably perpendicular to this front panel. A rear part in the form of a funnel is connected to the peripheral flange. On the internal surface of the front face, luminophore networks are arranged so as to form a screen for reproducing a colour image when the said networks are excited by electron beams from an electron gun arranged at the extremity of the rear part, an extremity in the form of a cylindrical collar.

An electromagnetic deflection device is arranged near the collar of the tube in such a manner as to deviate the electron beams from the gun and cause them to sweep over the surface of the screen.

Conventionally, the periphery of the panel is surrounded by a metal frame, known as an anti-implosion frame designed to increase the mechanical strength of the glass envelope. Indeed, when a vacuum is applied to the glass envelope, mechanical stress is applied to the front face and the peripheral flange under the influence of the atmospheric pressure outside the envelope.

The frame is generally equipped with lugs arranged at the four corners of the frame, these lugs being constituted by offset metal parts welded to the surface of the frame. The lugs are designed to support the tube in an enclosure, generally made of plastic, forming a display receiver for the television, for example.

It is known, for example through the document EP 0258946, that the anti-implosion frame installed around the front face of the tube is in the form of a loop, the free extremities of which are joined by means of an additional metal part arranged above these extremities and electrically spot welded to the extremities. The lugs attached to the frame have a noticeably L-shaped cross-section, the base of which follows the rounded surface of the corner of the frame to which it is welded.

The lug is conventionally spot welded to the frame; for this projections in the form of spherical caps are made on the surface of the lug designed to come into contact with the frame. Hence, before the welding, the lug touches the frame at the level of the points representing the summits of the spherical projections. This structure enables the welding energy to be concentrated in one point and the material to be fused in order to weld the lug to the frame. Each weld zone thus appears in a noticeably circular form, the dimension of which corresponds to the dimension of the projection arranged on the lug.

However, tubes with a flat front face and possibly with reduced depth, require the use of glass thicknesses constituting the envelope that are increasingly becoming thicker to counterbalance the mechanical forces related to the atmospheric pressure being applied to the said envelope under vacuum. The reduced depth tubes are tubes with a maximum deflection angle of the electronic beams that is greater than the conventional 110° and is generally greater than 115°. The shortening of the tube is achieved by shortening its rear part which must be thicker to support the stresses of the applied vacuum, which increases the final weight of the glass envelope.

To support the weight of such a tube, the welds of the lug to the frame, carried out according to the prior art must be multiplied, which leads to an extra cost and a complication of the automatic welding equipment.

One of the advantages of the invention is to enable welds of the lug to the frame to be obtained that are reliable in order to support the tube in its housing while avoiding the multiplication of the number of weld points; this is in spite of the significant increase in weight of the glass envelope.

### SUMMARY OF THE INVENTION

For this, the tube according to the invention comprises a glass envelope under vacuum comprising:
a glass panel comprising a noticeably flat front face 1 and a peripheral flange noticeably perpendicular to the said face,
a rear part in the form of a funnel, sealed at the front face at the level of the flange and terminating in a cylindrical collar within which an electron gun is arranged,
an electromagnetic deflection device designed to deflect the beams from an electron gun according to a maximum angle,
an anti-implosion metal frame arranged around the glass panel and at least partially covering the said flange on which are arranged the L-shaped cross-section lugs the base of which is welded to the frame,

characterized in that at least one of the weld zones of the base of the lug to the frame extends in a first direction over a length L and according to a second direction perpendicular to the first on a length l, shorter than the length L.

### BRIEF DESCRIPTION OF THE DRAWINGS

The invention and its different advantages will be better understood from the following description and drawings, wherein:

FIG. 1 shows a cathode ray tube with its main components,

FIGS. 2a and 2b show a mode of implementation of the invention according to the front and top views,

FIGS. 3a and 2b show a mode of implementation of the invention according to the front and bottom views,

FIGS. 4, 5a, 5b show the cross-section views of a lug according to the invention,

FIG. 6 shows a lug according to the invention in position on the frame of the tube.

### DETAILED DESCRIPTION OF THE INVENTION

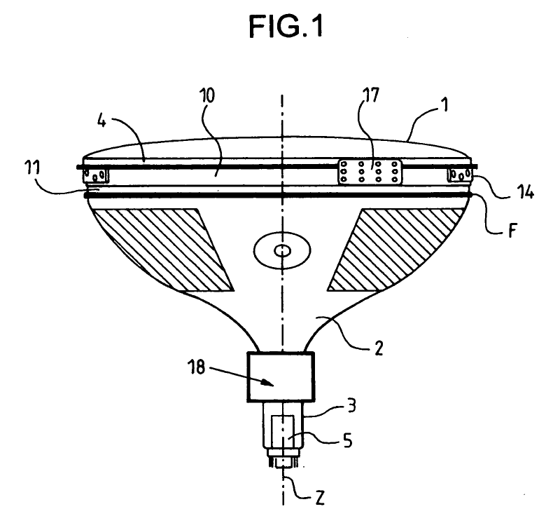

FIG. 1 shows an embodiment of a cathode ray tube according to the prior art. As shown in the figure, the tube comprises a panel 1 forming, with the rear part in the form of a funnel 2 terminating in a cylindrical collar 3, a glass envelope under vacuum. The panel and the rear tapered part are joined to each other by means of a line of glass frit F. The panel is of noticeably rectangular form delimited by a pair of long sides oriented in a horizontal direction X and a pair of short sides oriented in a vertical direction Y. The panel is composed of a front face delimited by a flange 11 perpendicular to the said face. Within the cylindrical collar 3, located at the end of the funnel part 2, is an electron gun 5 emitting at least one electron beam in the direction of a screen arranged on the internal surface of the front face 1. The longitudinal axis Z of the tube is perpendicular to the front face and passes through the centre of the screen. The screen is constituted by luminophore networks designed to reproduce an image under the impact of an electron beam. An electromagnetic deflection device 18 is arranged on the rear part of the tube and deviates the electron beam or beams so that the entire surface of the screen is swept over. When the tube is of the type to reproduce a colour picture, the electron gun emits three electron beams, each beam being designed to reproduce a primary colour: red, green, blue. An anti-implosion frame 10 is arranged on the flange 11 of the panel, a flange arranged between the front face and the sealing area with the rear part 2. The frame comprises in the corners of the tube lugs 14 enabling the tube to be attached within a box, generally produced using plastic materials. The frame is arranged around the tube in the following manner:
the frame is initially heated to a high temperature to increase its perimeter,
the heated frame is positioned around the tube and, through cooling, the reduction in its perimeter mechanically compresses the front of the tube.

The frame is generally composed of a folded metal strip 10, the extremities of which are joined by a plate 17 realized in a material having high mechanical strength or a great thickness, this is to be able to resist the strong traction forces exerted on these extremities when the frame arranged on the tube returns to the ambient temperature. The welding is a resistive spot welding as illustrated by FIG. 1.

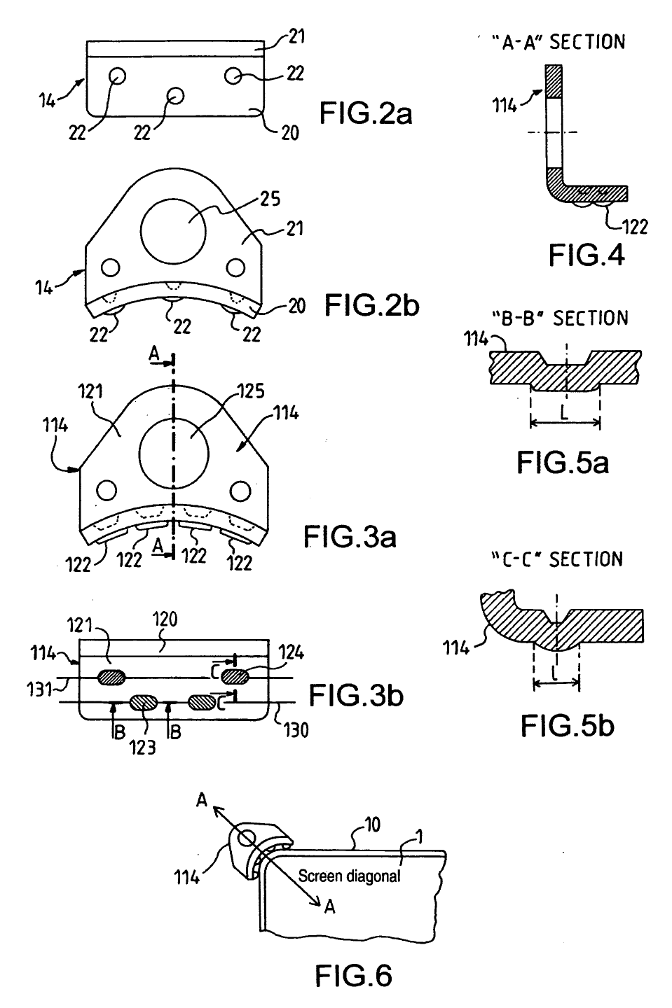

FIGS. 2a, 2b show in detail, according to different orientations, an attachment lug 14 according to prior art.

The lug 14 has an L cross-section with a base 20 designed to follow the roundness of the corner of the frame arranged on the flange 11 and a part 21, noticeably flat and perpendicular to the base 20. The part 21, generally arranged in a plane parallel to the front face of the tube, comprises a large aperture 25 designed to co-operate with a screw/nut system to hold the tube in place within the box to which it is designed to be joined.

The base 20 includes areas stamped in such a manner as to form projections 22 on the surface of the base that will come into contact with the frame when it is welded to the frame. These projections take the form of spherical caps and therefore, the resistive spot weld creates a weld zone between the parts of noticeably circular form.

In order to increase the mechanical strength of the welding to support the weight of a cathode ray tube, particularly when this tube is of reduced depth with a noticeably flat front face, the form of the projections created on the base of the lug according to the invention have been modified.

As shown in FIGS. 3a, 3b, 4, 5a and 5b illustrating an embodiment of a lug 114 according to the invention, projections 122 of an elongated form are arranged on the surface of the base 120 of the lug, a surface designed to come into contact with the anti-implosion frame.

In the embodiment illustrated by these figures and more specifically by FIGS. 5a and 5b, showing lugs for a flat front face tube with diagonal of 68 cm, the projections extend in a first direction, parallel to the plane of the front face, over a length L of 6 mm and according to a second direction perpendicular to the first over a length l of 4.2 mm. These forms of projections cause during resistive welding at the level of the contact areas, weld zones noticeably rectangular in shape, noticeably identical to the forms of the projections. The length L is preferentially oriented in such a manner as to be noticeably parallel to the flat front face of the tube and is therefore perpendicular to the longitudinal axis Z.

FIG. 3a illustrates, in a preferential embodiment, a lug according to the invention, presenting, in its noticeably flat part 121, perpendicular to the longitudinal axis Z, an aperture 125 for the passage of an attachment nut as well as a base 120 extending in a direction perpendicular to the part 121 and noticeably parallel to the longitudinal axis Z. On the surface designed to come into contact with the anti-implosion strip, the base comprises projections 122, rectangular in shape, arranged on either side of the plane perpendicular to the front face containing a diagonal AA. Experience shows that one or more projections located on the diagonal plane do not give good quality welds, as the radius of curvature of the base in this area is low and that it is better to have projections on either side of the diagonal plane.

Hence, lugs according to the invention have two pairs of projections 122, arranged symmetrically with respect to the middle of the base 120 which is in contact with the corner of the frame as shown in FIG. 6. Both pairs are arranged so as to extend according to parallel directions. Moreover, it is preferable that at least one of the projections extends in a plane different from the plane of the other projections, which helps to increase the solidity of the subsequent welds on the anti-implosion strip and which enables the number of welds to be limited.

Hence, in the preferential embodiment according to the invention, illustrated by FIG. 3b, the lug 114 will be welded according to two weld zones 123 extending in the directions contained in a same first plane 130 and two other weld zones 124 extending in directions contained in a same second plane 131 separate from the first.

The embodiments described herein are not restrictive. In the spirit of the invention, the number of projections and therefore the number of welds of the lug to the strip is not restricted, no more than the direction in which longest length of the weld zone extends, this last direction being able to be perpendicular, parallel or oblique with respect to the plane of the lug containing the aperture 125. Moreover, experience has shown that the advantages of an elongated weld shape are not noticeable when the ratio between its greatest length L and its width l becomes less than 1.3.

What is claimed is:

1/ Cathode ray tube comprising a glass envelope under vacuum comprising:
a glass panel comprising a noticeably flat front face and a peripheral flange noticeably perpendicular to the said face,
a rear part in the form of a funnel, sealed to the front face at the level of the flange and terminating in a cylindrical collar within which an electron gun is arranged,
an electromagnetic deflection device designed to deflect the beams from an electron gun according to a maximum angle,
an anti-implosion metal frame arranged around the glass panel and covering at least partially the said flange on which are arranged the L-shaped cross-section lugs whose base is welded to the frame,
wherein at least one of the weld zones of the base of the lug to the frame extends according to a first direction over a length L and according to a second direction perpendicular to the first over a length l, shorter than the length L.

2/ Cathode ray tube according to claim 1, wherein the first direction is parallel to the plane of the front face and the second direction is perpendicular to the plane of the said front face.

3/ Cathode ray tube according to claim 1, wherein L≧1.3 l.

4/ Cathode ray tube according to claim 1, wherein the number of weld zones for each lug is even and in that the welds are arranged on either side of the diagonal plane perpendicular to the front face.

5/ Cathode ray tube according to claim 4, wherein each lug comprises at least four weld zones.

6/ Cathode ray tube according to claim 5, wherein at least two weld zones extend in the first directions contained in a same first plane and that at least two other weld zones extend in the first directions contained in a same second plane separate from the first.

7/ Cathode ray tube according to claim 1, wherein the maximum angle of deflection is greater than 115°.
